(19) United States
(12) Patent Application Publication
(10) Pub. No.: US 2006/0263046 A1
(43) Pub. Date: Nov. 23, 2006

(54) Recording/playback apparatus, content management method, and content playback method

(75) Inventor: Kenichi Saito, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/493,640

(22) Filed: Jul. 27, 2006

Related U.S. Application Data
(63) Continuation of application No. PCT/JP04/19563, filed on Dec. 27, 2004.

(30) Foreign Application Priority Data
Jan. 30, 2004 (JP) 2004-024023

(51) Int. Cl. H04N 5/91

(52) U.S. Cl. 386/83

(57) ABSTRACT

According to one embodiment, a recording/playback apparatus for recording content transmitted from an external apparatus into a recorder on the basis of reservation information, comprises a recording controller which records, in the recorder, a first content to be recorded in the recorder on the basis of the reservation information, and a second content transmitted from the external apparatus after a time zone during which the first content is recorded, and a playback unit which plays back the content recorded in the recorder by the recording controller.

### CROSS REFERENCE TO RELATED APPLICATIONS

This is a Continuation Application of PCT Application No. PCT/JP2004/019563, filed Dec. 27, 2004, which was published under PCT Article 21(2) in Japanese.

This application is based upon and claims the benefit of priority from Japanese Patent Application No. 2004-024023, filed Jan. 30, 2004, the entire contents of which are incorporated herein by reference.

### BACKGROUND

1. Field

The present invention relates to a recording/playback apparatus having a recording function of digitally recording information such as a television broadcast, and a content management method and content playback method of the apparatus.

2. Description of the Related Art

When a user sets program reservation in an apparatus having functions of reservation recording of, e.g., images and sounds of information such as a television broadcast, the broadcast intended by the user cannot be entirely recorded in some cases, although information in the time zone intended by the user can be recorded. The broadcast intended by the user cannot be entirely recorded because, e.g., the scheduled broadcasting time is changed for the sake of convenience of programming, or a built-in clock of the apparatus is wrong. To solve this problem, various proposals have been made. It is disclosed by, for example, in Jpn. Pat. Appln. KOKAI Publication No. 2003-234986.

Unfortunately, no reliable convenient technique for solving the above problem has existed yet.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the basic configuration of the main parts of an electronic apparatus according to an embodiment of the present invention;

FIG. 2 is a view showing the format of automatic recorded data according to the embodiment of the present invention;

FIG. 3 is a schematic view showing a display example of an automatic recording setting window in a graphical user interface window according to the embodiment of the present invention;

FIG. 4 is a schematic view showing a display example of a recording reservation setting window in a graphical user interface window according to the embodiment of the present invention;

FIG. 5 is a schematic view showing a display example of an erase outline setting window in a graphical user interface window according to the embodiment of the present invention;

FIG. 6 is a schematic view showing a display example of an erase detail setting window in a graphical user interface window according to the embodiment of the present invention;

FIG. 7 is a block diagram showing details of the arrangement of the electronic apparatus according to the embodiment of the present invention;

FIG. 8 is a view showing the arrangement of a remote controller according to the embodiment of the present invention; and

FIG. 9 is a flowchart showing an example of the procedure according to the embodiment of the present invention.

### DETAILED DESCRIPTION

Various embodiments according to the invention will be described hereinafter with reference to the accompanying drawings. In general, according to one embodiment of the invention, a recording/playback apparatus for recording content transmitted from an external apparatus into a recorder on the basis of reservation information, comprises, a recording controller which records, in the recorder, a first content to be recorded in the recorder on the basis of the reservation information, and a second content transmitted from the external apparatus after a time zone during which the first content is recorded, and a playback unit which plays back the content recorded in the recorder by the recording controller.

According to another embodiment of the present invention, a content management method in a recording/playback apparatus comprising a recording controller which records a content transmitted from an external apparatus into a recorder on the basis of reservation information, comprises, recording, in the recorder, a first content to be recorded in the recorder on the basis of the reservation information, and a second content transmitted from the external apparatus after a time zone during which the first content is recorded.

According to still another embodiment of the present invention, a content playback method in a recording/playback apparatus comprising a recording controller which records a content transmitted from an external apparatus into a recorder on the basis of reservation information, and a playback unit which plays back the content recorded in the recorder by the recording controller, comprises, recording, in the recorder, a first content to be recorded in the recorder on the basis of the reservation information, and a second content transmitted from the external apparatus after a time zone during which the first content is recorded; and playing back, by using the playback unit, the first content recorded in the recorder, without playing back the second content recorded in the recorder thereafter.

An embodiment of the present invention will be described below with reference to the accompanying drawing.

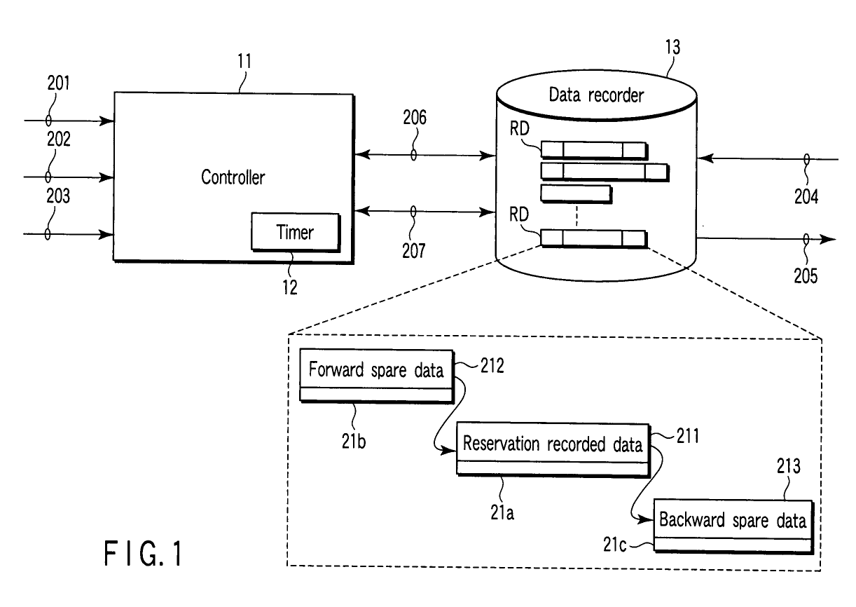

According to an embodiment, FIG. 1 shows an electronic apparatus having a controller 11 and data recorder 13. The controller 11 has a timer 12.

The controller 11 accepts a reservation recording request 201 based on user's setting, accesses the data recorder 13 by a control signal 206 under the time management by the timer 12, and records reserved input data 204 in the data recorder 13. Also, the controller 11 accepts an output request (not shown) based on user's setting, reads out data of the requested recorded program from the data recorder 13, and provides the user with output data 205.

In this embodiment, when data is recorded on the basis of the reservation recording request 201, data before and after this data are also recorded, in accordance with user's instructions.

That is, the controller 11 accepts an automatic recording request 202 and automatic recording time setting request 203. In accordance with these requests, the controller 11 records, for time periods designated by the automatic recording time setting request 203, data before and after the data based on the reservation recording request 201.

The data recorded on the basis of the reservation recording request 201 will be referred to as reservation recorded data 211, the data before the reservation recorded data 211 will be referred to as forward spare data 212, and the data after the reservation recorded data 211 will be referred to as backward spare data 213 hereinafter. Also, recorded data of each reserved program will be referred to as program recorded data RD hereinafter, regardless of the presence/absence of the spare data described above.

When recording each type of data, the controller 11 adds unique identification flags to the reservation recorded data 211, forward spare data 212, and backward spare data 213. In this embodiment, the controller 11 adds to the reservation recorded data 211 an identification flag 21a unique to this data, and adds to the forward spare data 212 and backward spare data 213 identification flags 21b and 21c, respectively, which indicate that these data are data (spare data) automatically acquired as backup data. The identification flags 21b and 21c can have the same value or different values. For example, to realize a function of separately providing the user with the forward spare data 212 and backward spare data 213, the identification flags 21b and 21c are given different values. On the other hand, to realize a function of simultaneously providing the user with the forward spare data 212 and backward spare data 213, the identification flags 21b and 21c are given the same value. The identification flags 21a, 21b, and 21c are transferred as control data 207 from the controller 11 to the data recorder 13, and recorded in the data recorder 13 as they are related to content data.

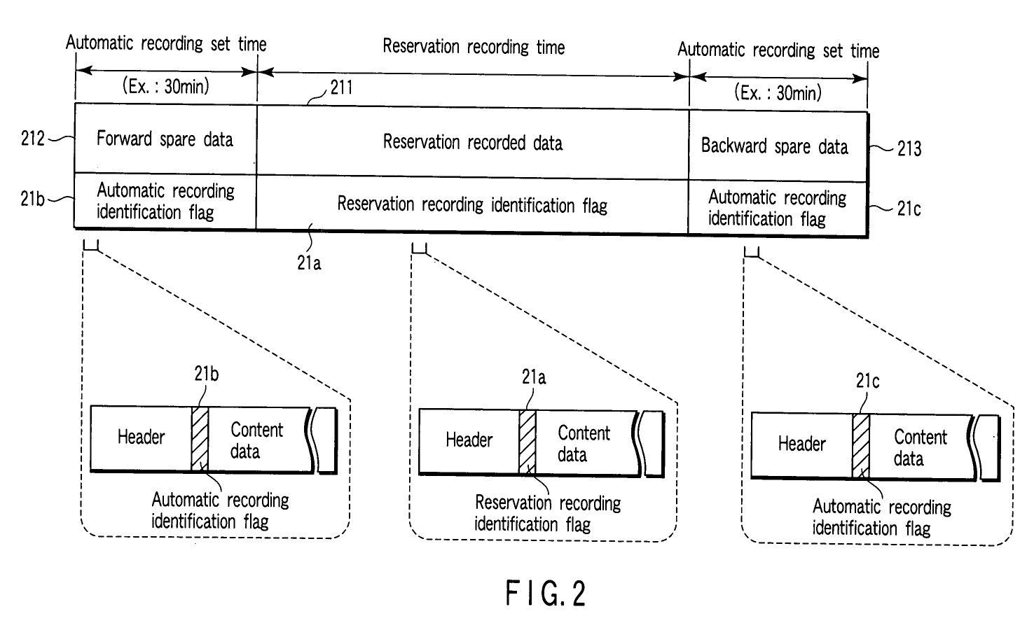

FIG. 2 shows an example of the addition of the identification flags 21a, 21b, and 21c. In this example, the identification flags 21a, 21b, and 21c are recorded, for each content data block having a predetermined unit, in the header of the reservation recorded data 211 corresponding to a time zone based on the reservation recording time, the header of the forward spare data 212, and the header of the backward spare data 213, respectively. The identification flag 21a added to the reservation recorded data 211 is referred to as a reservation recording identification flag, and the identification flags 21b and 21c added to the forward spare data 212 and backward spare data 213, respectively, are referred to as automatic recording identification flags. Note that FIG. 2 shows recording examples of the forward spare data 212 and backward spare data 213 when an automatic recording set time (zone) indicated by the automatic recording time setting request 203 is 30 min.

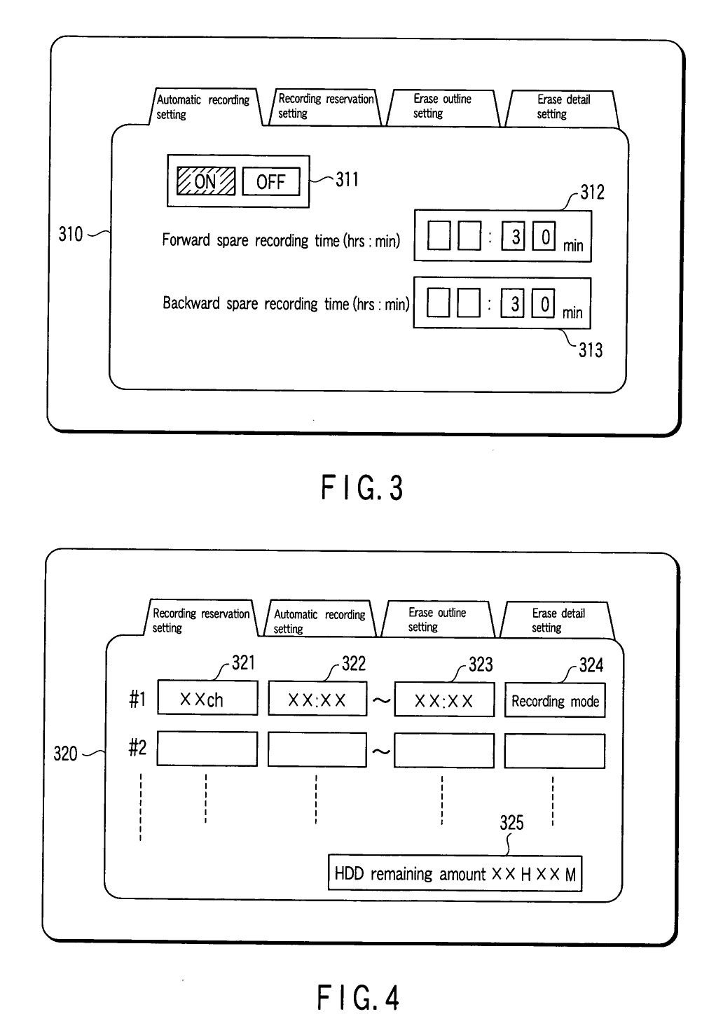

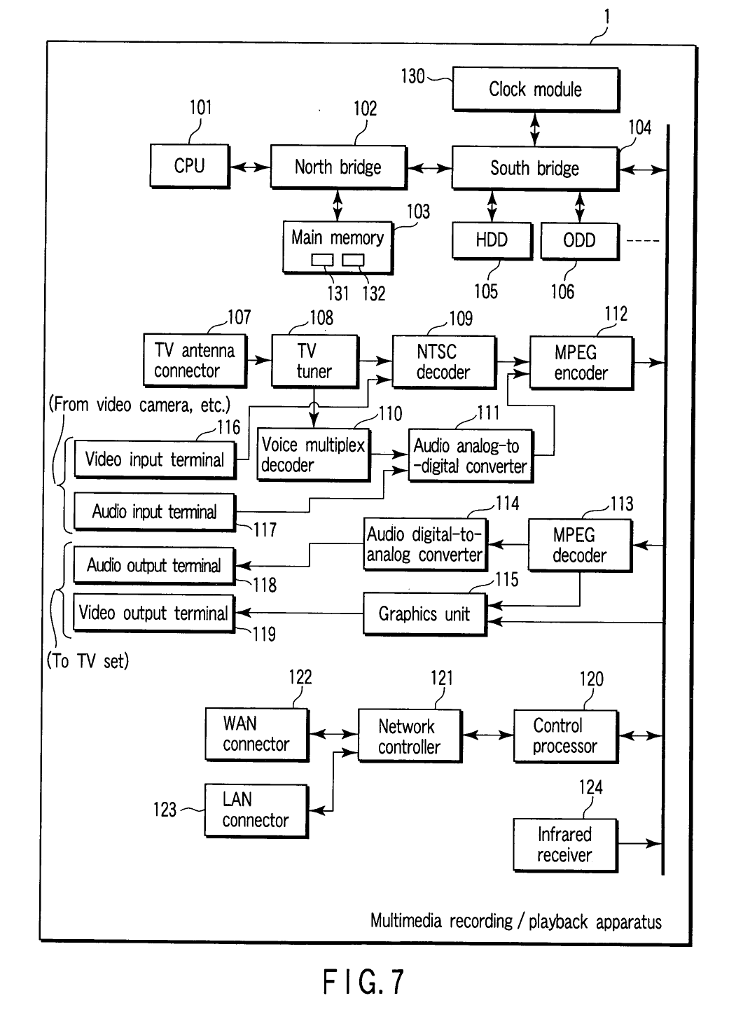

FIG. 3 shows an example of a graphical user interface window (automatic recording setting window) 310 for setting automatic recording on or off (valid/invalid), the automatic recording time, and the like related to, e.g., the automatic recording request 202 and automatic recording time setting request 203. FIG. 4 shows an example of a graphical user interface window (recording reservation setting window) 320 for setting recording reservation related to the reservation recording request 201. In this embodiment, the set contents of the graphical user interface window (automatic recording setting window) 310 shown in FIG. 3 are reflected on all recording reservation programs set in the graphical user interface window (recording reservation setting window) 320. However, it is also possible to set whether to automatically record the forward spare data 212 and backward spare data 213, and to set the time zones of these data when automatic recording is to be performed, from a forward spare recording time setting box 312 and backward spare recording time setting box 313, respectively, whenever a recording reservation program is set. In this case, the content of automatic recording set by using the graphical user interface window shown in FIG. 3 must be held (in an automatic recording setting table 132 shown in FIG. 7 to be described later) for each set recording reservation program.

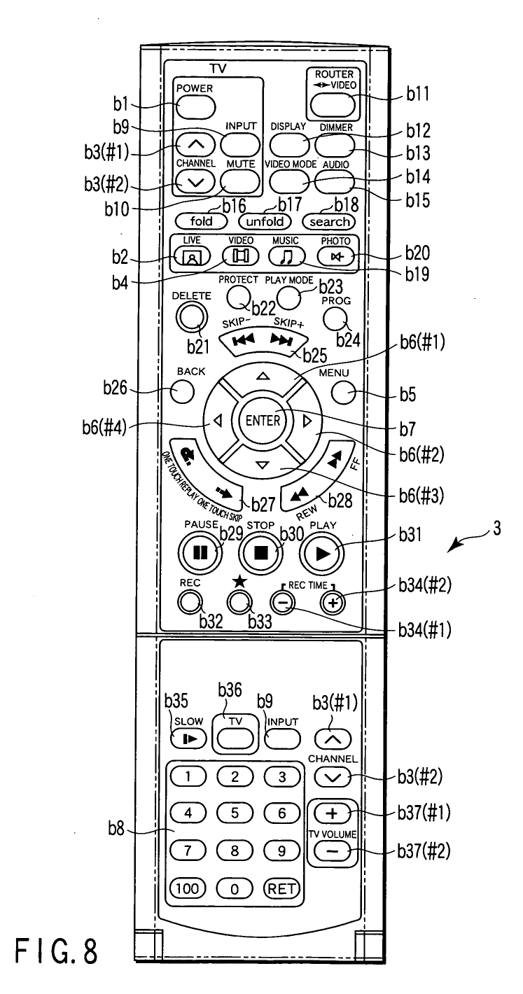

Examples of the setting operation in the graphical user interface window 310 shown in FIG. 3 are as follows. That is, whether to automatically record the forward spare data 212 and backward spare data 213 can be set by button operations of performing automatic recording (on)/no automatic recording (off) by using direction indicating buttons b6 (#1 to #4) of a remote controller 3 shown in FIG. 8. Alternatively, on and off buttons in an automatic recording setting box 311 in the graphical user interface window 310 shown in FIG. 3 are switched by a user's predetermined key operation, and one of these two buttons is selected by operating an enter key or the like. In short, the GUI need only have a function of allowing a user to set whether to automatically record the forward spare data 212 and backward spare data 213. Also, the automatic recording set time (zone) of each of the forward spare data 212 and backward spare data 213 can be set by setting a desired unit time (unit=30 min) by scroll switching by operating the remote controller 3 as shown in FIG. 8, or by setting any arbitrary time by using numeric buttons b8 or the like. In short, the GUI need only have a function of allowing a user to set the time zones of the forward spare data 212 and backward spare data 213. Referring to FIG. 3, the time zones of the forward spare data 212 and backward spare data 213 can be separately set. However, it is also possible to use a simplified display by which the time zones of the forward spare data 212 and backward spare data 213 are simultaneously set in one automatic recording set time setting field. In the graphical user interface window 320 shown in FIG. 4, when a desired recording mode is selected and set by a scroll operation from various recording modes such as high image quality/standard/extended time in a recording mode setting field 324, this setting is reflected in the remaining recording amount of the data recorder 13 and displayed in an HDD remaining amount display field 325. The graphical user interface window 320 shown in FIG. 4 also includes a channel display field 321 for displaying a channel to be recorded, a forward spare recording time field 322 for displaying the set forward spare recording time, and a backward recording time field 323 for displaying the set backward spare recording time.

When receiving an output (playback) request for a certain program, of the various program recorded data RD recorded in the data recorder 13, which is based on user's instructions, the controller 11 reads out program recorded data RD corresponding to the request from the data recorder 13, and provides the readout data as the output data 205 to the user. In this case, the controller 11 extracts the identification flags 21a, 21b, and 21c from the program recorded data RD, and outputs program recorded data RD having the reservation recording identification flag 21a shown in FIG. 2, and does not output program recorded data RD having the automatic recording identification flags 21b and 21c. Accordingly, program recorded data RD having the reserved time and time zone is transferred to the user.

If a difference is produced between the reservation recording time intended by the user and the contents of recording intended by the user because, e.g., a built-in clock of the apparatus is wrong or the program broadcasting time is changed, and if a portion of the intended recorded data is missing owing to this difference, the user enters an automatic setting output request. When receiving this automatic setting output request, the controller 11 reads out, from the data recorder 13, the forward spare data 212 and backward spare data 213 of the partially missing reservation recorded data 211 on the basis of the automatic recording identification flags 21b and 21c, and provides these data as the output data 205 to the user. This allows the user to compensate for the missing portion of the reservation recorded data 211.

Also, when receiving a recorded data erase request entered by the user by designating program recorded data RD, the controller 11 erases the recorded data corresponding to the request from the data recorder 13. In this case, the controller 11 erases the designated reservation recorded data 211 and the forward spare data 212 and backward spare data 213 before and after the reservation recorded data 211, on the basis of the automatic recording identification flags 21b and 21c. That is, when erasing recorded data, the controller 11 erases program recorded data RD including the forward spare data 212 and backward spare data 213 as a unit.

Note that in the present invention, it is not always necessary to erase the whole program recorded data RD. That is, it is also possible to erase only the forward spare data 212 and backward spare data 213 before and after the reservation recorded data 211, or to erase only one of the forward spare data 212 and backward spare data 213. Alternatively, so-called partial erasure is also possible by which only an arbitrary designated portion of the forward spare data 212 or backward spare data 213 is erased. Furthermore, it is possible to process the forward spare data 212, reservation recorded data 211, and backward spare data 213 as one program recorded data RD without regarding them as separate data, and to designate partial erasure of the program recorded data RD.

With these functions, only data to be left behind in the data recorder 13 can be left behind, without being erased, by designating a portion to be erased from the start position of the forward spare data 212, or by designating a portion to be erased from the end position of the backward spare data 213.

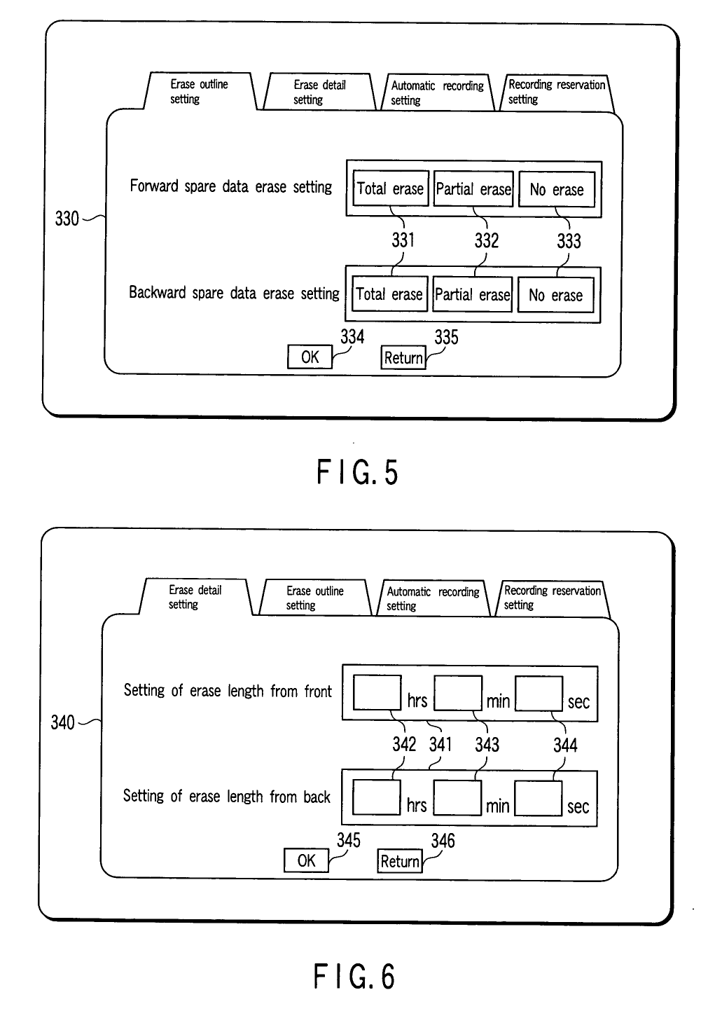

FIGS. 5 and 6 are views showing examples of graphical user interface windows for setting the erasing operations as described above. First, to totally erase the forward spare data 212 or backward spare data 213, in an erase outline setting graphical user interface window 330, the user operates a total erase button 331 of the corresponding spare data, and also operates an OK button 334, thereby totally erasing the designated spare data from the data recorder 13. For spare data not to be erased, the user operates a corresponding no erase button 333 and then operates the OK button 334, or operates a return button 335 without operates anything else.

To partially erase spare data, the user operates a partial erase button 332 of the corresponding spare data, and also operates the OK button 334, thereby displaying an erase detail setting graphical user interface window 340 as shown in FIG. 6. Then, the user inputs erase hours, minutes, and seconds of the corresponding spare data from an hour input box 342, minute input box 343, and second input box 344, respectively, of a time input box 341, and also operates an OK button 345, thereby erasing a portion having the designated length from the corresponding spare data.

That is, a portion having the designated length is erased from the start position of the forward spare data 212, or from the end position of the backward spare data 213. Since the forward spare data 212, reservation recorded data 211, and backward spare data 213 are not regarded as separate data but processed as one program recorded data RD, the designated hours, minutes, and seconds input in the time input box 341 can be longer than the length of the spare data; the excess time is erased from the reservation recorded data 211 following the spare data. For example, if erase of 40 minutes of the forward spare data 212 is designated in the time input box 341 while the length of the forward spare data 212 is 30 minutes, 10 minutes as the excess time is erased from the start position of the reservation recorded data 211.

Note that FIG. 6 shows the graphical user interface window 340 which designates a partial erase length by hours, minutes, and seconds. However, a partial erase length need not always be thus designated by hours, minutes, and seconds. That is, it is also possible to display the program recorded data RD from the start to the end by using a counter, and designate a portion to be erased by this counter. For example, when the count at the start point is “0” and the count at the end point is “1,000”, a portion to be erased is designated as “0 to 10” if 1% in the first half is to be erased, and a portion to be erased is designated as “970 to 1,000” if 3% in the second half is to be erased.

When it is unnecessary to designate any partial erase length, the user operates a return button 346.

If a difference is produced between the reservation recording time intended by the user and the contents of recording intended by the user because, e.g., a built-in clock of the apparatus is wrong or the program broadcasting time is changed, the data recording control function described above makes it possible to easily acquire and play back information of a portion which is missing owing to this difference.

The arrangement and operation of a more practical apparatus of the above embodiment will be explained below.

FIG. 7 shows a more practical arrangement of the apparatus shown in FIG. 1. That is, FIG. 7 shows the arrangement of a multimedia recording/playback apparatus 1.

The multimedia recording/playback apparatus 1 has a CPU 101 and its peripheral elements for implementing the controller 11 shown in FIG. 1, a television (TV) tuner 108 and its peripheral elements capable of acquiring data to be recorded which corresponds to the input data 204 shown in FIG. 1, and a hard disk drive (HDD) 105 and its peripheral elements which correspond to the data recorder 13 shown in FIG. 1, and record data of a program whose recording is reserved.

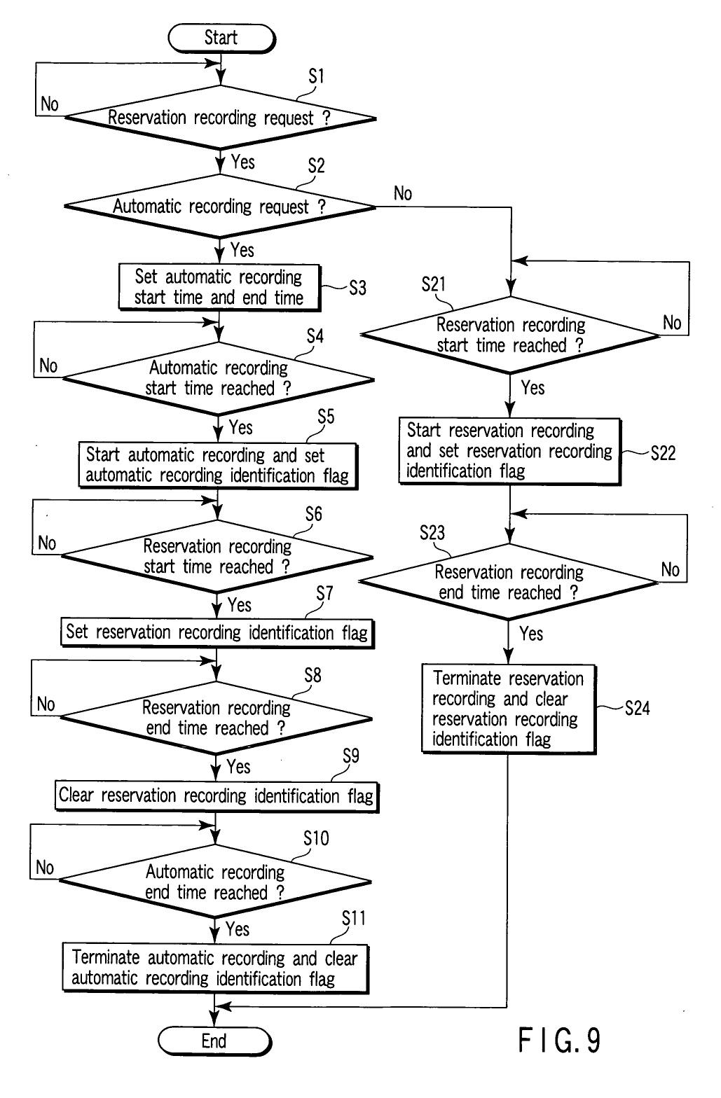

The CPU 101 controls the whole multimedia recording/playback apparatus 1, i.e., controls access to a main memory 103 via a north bridge 102, and executes various programs stored in the main memory 103. The main memory 103 stores a display control program which is a part of a user interface of the multimedia recording/playback apparatus 1, and also stores a recording control program 131 including process routines for implementing the functions of setting automatic recording, recording reservation, and erase as explained above with reference to FIGS. 1 to 6, and the functions of managing and controlling data in accordance with these settings, and an automatic recording setting table 132 which the recording control program 131 looks up. The procedure of a process routine (to be referred to as an automatic recording process routine hereinafter) of the recording control program 131 according to the embodiment of the present invention will be described later with reference to FIG. 9. The automatic recording setting table 132 holds the set contents of turning automatic recording on and off, the automatic recording time, and the like which are set by using the graphical user interface window 310 as shown in FIG. 3. To simplify the explanation, it is assumed that the set content in the automatic recording setting table 132 are reflected in all the program recorded data RD recorded in the hard disk drive (HDD) 105. Note that the recording control program 131 also includes process routines for implementing a GUI function using the graphical user interface window 310 as shown in FIG. 3, and a function of forming the automatic recording setting table 132 corresponding to the content set by this GUI function.

The north bridge 102 is connected to a south bridge 104. The CPU 101 and main memory 103 are connected to a system bus 100 via the north bridge 102 and south bridge 104. The south bridge 104 controls driving of various peripheral devices, such as the hard disk drive (HDD) 105 and an optical disk drive (ODD) 106. Television program data, video data, music data, photograph data, and the like are recorded in the HDD 105 and ODD 106. The south bridge 104 is also connected to a clock module (RTC) 130 corresponding to the timer 12 shown in FIG. 1, and used to control the execution of recording reservation, automatic recording, and the like.

A TV antenna installed on the roof or the like is connected to the multimedia recording/playback apparatus 1 via a TV antenna connector 107. An input TV signal from the TV antenna connector 107 is transferred to the TV tuner 108. The TV tuner 108 receives TV broadcast data of a channel requested from the remote controller 3 as shown in FIG. 8, or from a personal computer or the like across a LAN. On the basis of this request, the TV tuner 108 receives TV signals and selects a channel.

A video signal of a TV broadcast of a certain channel received by the TV tuner 108 is transmitted to an NTSC decoder 109 and converted into digital data. Also, an audio signal is transmitted from a voice multiplex decoder 110 to an audio analog-to-digital converter 111 and converted into a digital signal. The voice multiplex decoder 110 interposed between the TV tuner 108 and audio analog-to-digital converter 111 decodes, where necessary, a voice multiplexed signal superposed on TV broadcast data.

The NTSC decoder 109 is also connected to a video input terminal 116, and can receive a video signal from an external video apparatus such as a DVD player. The audio analog-to-digital converter 111 is also connected to an audio input terminal 117, and can receive an audio signal from an external audio (video) apparatus.

An MPEG encoder 112 compression-codes input video and audio data. MPEG2 is used in this compression coding. TV broadcasting program data received by the TV tuner 108 is compression-coded and converted into an MPEG2 stream by the MPEG encoder 112. This compression-coded TV broadcasting program data is transferred, via the system bus 100, to an MPEG decoder 113 when the data is to be viewed on a TV set (not shown), to a control processor 120 (to be described later) when the data is to be viewed on a personal computer or the like across a LAN, or to the hard disk drive (HDD) 105 when the data is to be recorded.

The MPEG decoder 113 decodes the TV broadcasting program data compression-coded into the format of MPEG2. For example, when compression-coded TV broadcasting program data recorded in the hard disk drive (HDD) 105 is to be viewed on a TV set, this compression-coded TV broadcasting program data read out from the hard disk drive (HDD) 105 is transmitted to and decoded by the MPEG decoder 113.

The video data decoded by the MPEG decoder 113 is supplied to a graphics unit 115, and transmitted to a TV set via a video output terminal 119. Also, the audio data similarly decoded by the MPEG decoder 113 is converted into an analog signal by an audio digital-to-analog converter 114, and transmitted to the TV set via an audio output terminal 118. The graphics unit 115 can superpose image data formed by the CPU 101 onto the video data decoded by the MPEG decoder 113.

A WAN connector 122 is a terminal used to exchange data with the Internet. A LAN connector 123 is a terminal used to exchange data with a LAN. A network controller 121 is a network control device for controlling data exchange performed with the Internet via the WAN connector 122, and data exchange performed with the LAN via the LAN connector 123. The control processor 120 controls the network controller 121 in accordance with instructions from the CPU 101.

An infrared receiver 124 receives an infrared signal transmitted from the remote controller 3 as shown in FIG. 8, and transmits the content of an operation indicated by the infrared signal to the CPU 101. More specifically, when receiving an infrared signal, the infrared receiver 124 stores the operation information in a built-in register, and generates an interrupt to the CPU 101. When the CPU 101 requests to refer to the built-in register in response to this interrupt, the infrared receiver 124 outputs the operation information to the system bus.

FIG. 8 shows the external appearance and the arrangement of operation buttons of the remote controller 3 used to remotely control the multimedia recording/playback apparatus 1 having the above arrangement. By operating a POWER button b1 of the remote controller 3, the power supply of the multimedia recording/playback apparatus 1 can be turned on/off. A TV program of a given channel can be viewed by operating a LIVE button b2 and CHANNEL up/down buttons b3(#1)/b3(#2). Program recorded data RD recorded by reservation can be viewed by operating a VIDEO button b4. By operating a MENU button b5, various menu windows including the setting windows as shown in FIGS. 3 and 4 can be selectively displayed on the TV screen.

Also, automatic recording can be set in the graphical user interface window (automatic recording setting window) 310 as shown in FIG. 3 by using the up, down, left, and right direction indicating buttons b6(#1 to #4), an ENTER button b7, the numeric buttons b8, and the like. For example, turning automatic recording on and off can be switched and selected by operating the direction indicating buttons b6(#1 to #4), and determined by operating the ENTER button b7. It is also possible to set recording reservation in the graphical user interface window (recording reservation setting window) 320 as shown in FIG. 4, by using the direction indicating buttons b6(#1 to #4), ENTER button b7, numeric buttons b8, CHANNEL up/down buttons b3(#1)/b3(#2), and the like.

In addition to these buttons, the remote controller 3 has, e.g., a TV input button b9, mute button b10, router/video switching button b11, display button b12, DIMMER button b13, video mode select button b14, audio select button b15, hold button b16, hold release button b17, search button b18, music button b19, photo button b20, erase button b21, protect designating button b22, play mode select button b23, program button b24, skip button b25, back button b26, one touch replay/one touch skip button b27, rewind/fast forward button b28, pause button b29, stop button b30, play button b31, record button b32, help button b33, and recording time set buttons b34(#1 and #2). The remote controller 3 further includes a slow-motion playback button b35, TV select button b36, and TV volume up/down buttons 37(#1 and #2).

FIG. 9 shows the procedure including the automatic recording process routine of the recording-control program 131 based on the settings in the graphical user interface window (automatic recording setting window) 310 and graphical user interface window (recording reservation setting window) 320.

The CPU 101 executes a process routine including the automatic recording process of the recording control program 131 at a predetermined period. In this process, the CPU 101 checks, at a predetermined period, the presence/absence of the reservation recording request 201 based on the settings of recording reservation (step S1). If no recording reservation is set (if no reservation recording request is present) (NO in step S1), the CPU 101 checks the presence/absence of a reservation recording request again at the predetermined period. If recording reservation is set (if a reservation recording request is present) (YES in step S1), the CPU 101 checks the presence/absence of the automatic recording request 202 based on the on/off setting of automatic recording (step S2).

If no automatic recording request is present (if automatic recording is off) (NO in step S2), the CPU 101 performs data recording corresponding to the recording reservation time, in the same manner as in the existing system which does not perform any automatic recording of the forward spare data 212 and backward spare data 213 (steps S21 to S24). In this processing, the CPU 101 starts reservation recording when the reservation recording start time is reached (YES in step S21), and records, in the hard disk drive (HDD) 105, data corresponding to the reservation by attaching the reservation recording identification flag 21a to the content data (step S22). When the reservation recording end time is reached (YES in step S23), the CPU 101 terminates the recording of the reserved data, and clears the reservation recording identification flag 21a (step S24).

If an automatic recording request is found (if automatic recording is on) in the automatic recording request presence/absence determination (YES in step S2), the CPU 101 calculates the automatic recording start time at which acquisition of the forward spare data 212 is started and the automatic recording end time at which acquisition of the backward spare data 213 is terminated, in accordance with the reservation recording request 201 and the automatic recording time setting request 203 which is based on the set automatic recording time, thereby setting the automatic recording set times before and after the reservation (step S3).

When the automatic recording start time is reached (YES in step S4), the CPU 101 starts recording the forward spare data 212 (FIG. 2), adds the automatic recording identification flag 21b to the content data, and records the forward spare data 212 in the hard disk drive (HDD) 105 (step S5). When the reservation recording start time is reached after that (YES in step S6), the CPU 101 continues data recording by switching automatic recording to reservation recording, adds the reservation recording identification flag 21a to the content data, and records the data based on the reservation in the hard disk drive (HDD) 105 (step S7). When the reservation end time is reached (YES in step S8), the CPU 101 continues data recording by switching reservation recording to automatic recording, adds the automatic recording identification flag 21c to the content data, and starts recording the backward spare data 213 (step S9). When the automatic recording end time is reached (YES in step S10), the CPU 101 stops recording the backward spare data 213 (step S11).

As described above, when recording reservation by which automatic recording is on is performed, as shown in FIG. 2, program recorded data RD is recorded by attaching the forward spare data 212 and backward spare data 213 to the reservation recorded data 211.

When, after data reserved by recording reservation by which automatic recording is on is recorded in the hard disk drive (HDD) 105, the user operates the VIDEO button b4, PLAY button b31, and the like of the remote controller 3 to request playback of the recorded data, the CPU 101 reads out, in response to this playback request, the program recorded data RD corresponding to the playback request from the hard disk drive (HDD) 105, and transmits the program recorded data RD to the TV set via the MPEG decoder 113, graphics unit 115, and video output terminal 119. The audio data is also transmitted to the TV set via the MPEG decoder 113, audio digital-to-analog converter 114, and audio output terminal 118.

When outputting (playing back) the program recorded data RD, the CPU 101 checks the content of the identification flags (21a, 21b, and 21c) attached to the content, and discriminates between the reservation recorded data 211 having the reservation recording identification flag 21a attached, and the forward spare data 212 and backward spare data 213 having the automatic recording identification flags 21b and 21c attached, respectively. The CPU 101 excludes the forward spare data 212 and backward spare data 213 from an output object, and transmits the reservation recorded data 211 as an output object to the MPEG decoder 113. Under the normal use condition, therefore, the reservation recorded data 211 matching the reserved time is played back.

If a difference is produced between the reservation recording time intended by the user and the played back recorded contents intended by the user, and if a portion of the intended recorded data is missing owing to this difference, the user enters an automatic setting output request. This allows the user to acquire and play back the forward spare data 212 and backward spare data 213 including the missing portion. That is, on the basis of this automatic setting output request, the CPU 101 extracts the forward spare data 212 and backward spare data before and after the reservation recorded data 211 from which the partial data is missing, and transmits the extracted data to the MPEG decoder 113, thereby providing the user with the recorded data (forward spare data 212 and backward spare data 213) of time zones before and after the reservation recorded data 211. This data extraction of the forward spare data 212 and backward spare data 213 is realized by extracting the content data having the automatic recording identification flags 21b and 21c, and transmitting the extracted content data to the MPEG decoder 113.

When receiving a recorded data delete request entered by the user by designating a recorded program, the CPU 101 erases the recorded data corresponding to the request from the hard disk drive (HDD) 105. That is, on the basis of the automatic recording identification flags 21b and 21c, the CPU 101 erases the designated reservation recorded data 211 and the forward spare data 212 and backward spare data 213 before and after the reservation recorded data 211, i.e., erases the whole program recorded data RD.

In the present invention, it is not always necessary to erase the whole program recorded data RD as described above. That is, it is also possible to leave the reservation recorded data 211 behind and erase only the forward spare data 212 and backward spare data 213 before and after the reservation recorded data 211, or to erase only one of the forward spare data 212 and backward spare data 213.

Furthermore, only a given designated portion of the forward spare data 212 or backward spare data 213 can also be erased. Additionally, it is also possible to process the forward spare data 212, reservation recorded data 211, and backward spare data 213 as one program recorded data RD without regarding them as separate data, and to designate partial erasure of the program recorded data RD.

If a difference is produced between the reservation recording time intended by the user and the content of recording intended by the user because, e.g., a built-in clock of the apparatus is wrong or the program broadcasting time is changed, the data recording control function as described above makes it possible to easily acquire and play back information of a portion which is missing by this difference.

Also, a given unnecessary portion can be erased from the program recorded data RD, so only a necessary portion can be recorded in the data recorder 13. Accordingly, the limited capacity of the data recorder 13 can be effectively used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording/playback apparatus for recording content transmitted from an external apparatus into a recorder on the basis of reservation information, comprising:
a recording controller which records, in the recorder, a first content to be recorded in the recorder on the basis of the reservation information, and a second content transmitted from the external apparatus after a time zone during which the first content is recorded; and
a playback unit which plays back the content recorded in the recorder by the recording controller.

2. An apparatus according to claim 1, wherein the playback unit does not play back the second content after playing back the first content.

3. An apparatus according to claim 1, wherein the recording controller records, in the recorder, a third content transmitted from the external apparatus before the time zone during which the first content is recorded in the recorder.

4. An apparatus according to claim 3, wherein the playback unit plays back the first content without playing back the third content, and does not play back the second content after playing back the first content.

5. An apparatus according to claim 3, further comprising a setting unit which sets a time during which the third content is recorded in the recorder.

6. An apparatus according to claim 3, further comprising an erase unit which erases the first content recorded in the recorder, together with the second and third contents recorded in the recorder.

7. An apparatus according to claim 3, further comprising an erase unit which erases a portion equivalent to a length designated from a start position and a portion equivalent to a length designated from an end position of an integrated content obtained by sequentially combining, in an order named, the third, first, and second contents recorded in the recorder.

8. An apparatus according to claim 3, further comprising an erase unit which erases at least one of the second and third contents recorded in the recorder, without erasing the first content recorded in the recorder.

9. An apparatus according to claim 8, wherein when the second content is to be erased, the erase unit erases only a portion equivalent to a length designated from an end position of the second content, and, when the third content is to be erased, the erase unit erases only a portion equivalent to a length designated from a start position of the third content.

10. An apparatus according to claim 1, which further comprises a selector which selects a content recorded in the recorder by the recording controller, and
in which the playback unit plays back the content selected by the selector.

11. An apparatus according to claim 1, which further comprises:
an addition unit which adds, to a content recorded in the recorder by the recording controller, identification information of the content; and
a selector which selects the content on the basis of the identification information added to the content by the addition unit, and
in which the playback unit plays back the content selected by the selector.

12. An apparatus according to claim 1, further comprising an erase unit which erases both the first and second contents recorded in the recorder.

13. An apparatus according to claim 1, further comprising a setting unit which sets a time during which the second content is recorded in the recorder.

14. A content management method in a recording/playback apparatus comprising a recording controller which records a content transmitted from an external apparatus into a recorder on the basis of reservation information, comprising:
recording, in the recorder, a first content to be recorded in the recorder on the basis of the reservation information, and a second content transmitted from the external apparatus after a time zone during which the first content is recorded.

15. A method according to claim 14, further comprising recording, in the recorder, a third content transmitted from the external apparatus before the time zone during which the first content is recorded in the recorder.

16. A method according to claim 15, further comprising erasing a portion equivalent to a length designated from a start position and a portion equivalent to a length designated from an end position of an integrated content obtained by sequentially combining, in an order named, the third, first, and second contents recorded in the recorder.

17. A method according to claim 15, further comprising erasing at least one of the second and third contents recorded in the recorder, without erasing the first content recorded in the recorder.

18. A method according to claim 17, wherein when the second content is to be erased, only a portion equivalent to a length designated from an end position of the second content is erased, and, when the third content is to be erased, only a portion equivalent to a length designated from a start position of the third content is erased.

19. A content playback method in a recording/playback apparatus comprising a recording controller which records a content transmitted from an external apparatus into a recorder on the basis of reservation information, and a playback unit which plays back the content recorded in the recorder by the recording controller, comprising:
recording, in the recorder, a first content to be recorded in the recorder on the basis of the reservation information, and a second content transmitted from the external apparatus after a time zone during which the first content is recorded; and
playing back, by using the playback unit, the first content recorded in the recorder, without playing back the second content recorded in the recorder thereafter.

20. A method according to claim 19, further comprising:
recording, in the recorder, a third content transmitted from the external apparatus before the time zone during which the first content is recorded in the recorder; and
playing back, by using the playback unit, the first content recorded in the recorder, without playing back the third content recorded in the recorder.

21. A method according to claim 20, further comprising erasing a portion equivalent to a length designated from a start position and a portion equivalent to a length designated from an end position of an integrated content obtained by sequentially combining, in an order named, the third, first, and second contents recorded in the recorder.

22. A method according to claim 20, further comprising erasing at least one of the second and third contents recorded in the recorder, without erasing the first content recorded in the recorder.

23. A method according to claim 21, wherein when the second content is to be erased, only a portion equivalent to a length designated from an end position of the second content is erased, and, when the third content is to be erased, only a portion equivalent to a length designated from a start position of the third content is erased.
